(19) United States
(12) Patent Application Publication
(10) Pub. No.: US 2010/0183411 A1
(43) Pub. Date: Jul. 22, 2010

(54) Load Bearing Frame

(76) Inventor: Anthony Holyoak, Eye (GB)

Correspondence Address: DEVINE, MILLIMET & BRANCH, P.A., 111 AMHERST STREET, BOX 719, MANCHESTER, NH, 03105, US

(21) Appl. No.: 12/666,882

(22) PCT Filed: Jun. 25, 2008
(86) PCT No.: PCT/GB2008/002166

§ 371 Date: Jan. 8, 2010

(30) Foreign Application Priority Data
Jun. 28, 2007 (GB) 0712724.4

(51) Int. Cl. B60P 3/40

(52) U.S. Cl. 414/462

(57) ABSTRACT

The present invention relates to a load bearing frame (1), and in particular to a load bearing frame (1) for mounting to the rim (2) of a rear cargo box area (4) of pickup truck (6) or other light motor vehicle. The load bearing frame (1) comprises mounting means 8 for mounting the frame (1) to a rim (2) of the cargo box area (4), an elongate load bearing member (10), said member defining a longitudinal direction (12) and having opposite first and second ends (18, 19), and supporting means (20-24) for supporting the load bearing member 10 on the mounting means (8). The supporting means (20-24) is arranged to support the first end (18) of the load bearing member (10) at a higher level above the mounting means (8) than the second end (19) of the load bearing member (10), such that the load bearing frame (1) may, in use, be mounted to the rim (2) of the cargo box area (4) with the first end (18) above a forwards portion (28) of the cargo box area (4) and the second end (19) above a rearwards portion (29) of the cargo box area (4).

### BACKGROUND

a. Field of the Invention

The present invention relates to a load bearing frame, and in particular to a load bearing frame for mounting to the rim of a rear cargo box area of a pickup truck or other light motor vehicle.

b. Related Art

Light motor vehicles such as pickup trucks, have a rear cargo box area, which is normally kept open, and which can be loaded with a variety of goods or materials, either through the open top or through the tail gate provided at the rear of the cargo area. A difficulty arises if the vehicle is to be used to carry goods or materials which will not fit completely within the cargo box, either because these are too long or too wide. If the load is too long, it may be possible to carry the load with the tail gate rotated to a down position, and if the goods are too wide it may be possible to fix the load to a rim of the cargo box area, or place the load partially within the cargo box area, and extending over and resting partially on the rim on the left or right sides of the cargo box area.

Problems arise with such make-shift solutions, either due to safety limits which define a maximum safe width or length of the vehicle and its load, or because the overly wide or long load is not correctly supported.

A further limitation may arise when carrying sheet material loads, for example plasterboard or sheet glass, which need to be kept flat. Even if the sheet material fits entirely within the cargo box area, resting for example on a flat floor to the cargo box area, it may not be possible or easy to make full use of the load carrying volume of the cargo box area, because it may not be possible to rest other materials or goods on top of the sheet material.

It is an object of the present invention to address these issues.

### SUMMARY OF THE INVENTION

According to the invention, there is provided a load bearing frame for mounting to a motor vehicle having an open-top rear cargo box area, the frame comprising:
mounting means for mounting the frame to a rim of the cargo box area;
a load bearing member for carrying sheet loads, said member defining a longitudinal direction and having opposite first and second ends;
supporting means for supporting the load bearing member on the mounting means; and
means for restraining in the longitudinal direction a sheet load placed on the load bearing member;

wherein the supporting means is arranged to support the first end of the load bearing member at a higher level above the mounting means than the second end of the load bearing member, such that the load bearing frame may, in use, be mounted to the rim of the cargo box area with the first end above a forwards portion of the cargo box area and the second end above a rearwards portion of the cargo box area, and said longitudinal restraining means is extendable in the longitudinal direction from said first end and/or said second end so that in use sheet loads of differing length can be carried by the load bearing member.

Also according to the invention, there is provided a light motor vehicle, comprising an open-top rear cargo box area, the vehicle having a load bearing frame comprising:
mounting means for mounting the frame to a rim of the cargo box area;
a load bearing member for carrying sheet loads, said member having opposite first and second ends;
supporting means for supporting the load bearing member on the mounting means; and
means for restraining in the longitudinal direction a sheet load placed on the load bearing member;

wherein the supporting means is arranged to support the first end of the load bearing member at a higher level above the mounting means than the second end of the load bearing member, such that the load bearing frame is mounted to the rim of the cargo box area with the first end above a forwards portion of the cargo box area and the second end above a rearwards portion of the cargo box area, and said longitudinal restraining means is extendable in the longitudinal direction from said first end and/or said second end so that in use sheet loads of differing length can be carried by the load bearing member.

The load bearing member is preferably elongate along the longitudinal direction.

Although the load bearing frame may be loaded and unloaded from the side, it will generally be more convenient if goods or materials, particularly in sheet form, may then be loaded on the load bearing frame from the rear end of the cargo box area, for example by moving or sliding the goods or materials forwards and upwards along the load bearing member of the load bearing frame. When the goods or materials are to be unloaded, the process may be reversed by moving or sliding the goods or materials backwards and downwards along the load bearing member of the load bearing frame.

The frame comprises means for restraining in a longitudinal direction a sheet load placed on the load bearing member. The frame may additionally or alternatively comprise means for restraining in a horizontal direction transverse to the longitudinal direction a load placed on the load bearing member.

The longitudinal restraining means is extendable in the longitudinal direction from the first end and/or said second end. Optionally, the horizontal restraining means may be extendable in the horizontal direction left and/or right with respect to the longitudinal direction.

The longitudinal restraining means may include a bracket extending upwards from one or both ends of the load bearing member, in which case, this bracket may include a clamp for clamping a load towards the load bearing member.

The transverse restraining means may include a bracket extending upwards at one or both sides of the load bearing member, in which case this bracket may include a clamp for clamping a load towards the load bearing member.

The load bearing member is preferably removeably affixed to the mounting means via the supporting means. Then when the load bearing frame is not in use, the load bearing member can be removed from the mounting means, for example for stowage in the cargo box area or for storage elsewhere.

The supporting means may include pivoting means by which the load bearing member may pivot with respect to the mounting means. Thus, in use, the load bearing member may be pivoted to gain better access to the cargo box area. The pivoting means may permit the load bearing member to be pivoted to a substantially vertically extending orientation. The pivoting means then preferably includes means for temporarily securing the load bearing member in said vertically extending orientation.

In a preferred embodiment of the invention, the supporting means includes a pair of pins extending in opposite horizontal directions. The pins each then engage in a pivot affixed to the mounting means.

These pins are preferably provided with a non-circular cross-section with a major cross-sectional axis and a minor cross-sectional axis, and each of the pivots is preferably provided in a pivot bracket, with each of these pivot brackets having a first channel extending upwardly from the pivot. At least a portion of each of the first channels may then have a width sufficient to allow passage for the minor cross-sectional axis but not the major cross-sectional axis. In this manner, the minor cross-sectional axes of the pins can be oriented to permit passage of the pins through this first channel when the load bearing member is pivoted to a vertical orientation, but not otherwise.

One advantage of this arrangement is that each of these first channels can be formed to lead to an opening which permits the load bearing frame to be removed from the bracket by moving the load bearing frame upwards with respect to the bracket. Similarly, the load bearing member can be assembled to the bracket, and hence the mounting means by orienting the load bearing member upright or vertical, and then inserting the pin into the opening leading to the first channel and then through the first channel into location with the pivot. The load bearing member can then be rotated downwards and secured to the mounting means. In this orientation the pin can no longer be removed from the pivot through the channel owning to the increased diameter of the pin relative to the first channel.

In a preferred embodiment of the invention, each bracket has a second channel connected to the first channel, with each second channel being offset in a longitudinal direction relative to the corresponding pivot. The load bearing frame may then comprise a pair of projections, each of these projections being in fixed proximity with a corresponding one of the pins, the arrangement being such that the load bearing member when in a substantially vertical orientation can be moved to engage both pins and both projections in the second channel to secure the load bearing member in a substantially vertical orientation.

The first and second channels together may form an inverted U-shape plus a section of channel extending upwardly from said inverted U-shape towards an opening to these channels through which the pin passes when the load bearing member is being fixed to or removed from the pivots.

The supporting means preferably includes at the first end and/or at the second end of the load bearing member a horizontally extending transverse member. If this is at the same level as the longitudinal load bearing member, such a horizontally extending transverse member may also serve to bear some of the load on the load bearing frame.

The supporting means preferably includes a pair of legs which in use extend downwardly from the load bearing member to a forward portion of the mounting means.

### BRIEF DESCRIPTION OF THE DRAWINGS

The invention will now be further described, by way of example only, with reference to the accompanying drawings, in which:

FIG. 1 is a side view of a load bearing frame according to a first preferred embodiment of the invention, having an upwards sloping longitudinal load bearing member shown affixed to the rim of an open-top rear cargo box area of a pick-up truck;

FIG. 2 is a side view similar to that of FIG. 1, in which a rearwards extension of the load bearing member has been retracted;

FIG. 3 is a side view of the load bearing frame when collapsed horizontally;

FIG. 4 is a side view of the load bearing frame, when the load bearing member is stowed inside the cargo box area, after disassembly from a supporting tubular tie bar which remains affixed to the rim of the cargo box area;

FIG. 5 is a top plan view of the stowed load bearing member and tie bar of FIG. 4;

FIGS. 6 and 7 are, respectively, top and side views of the tie bar, showing a U-shaped pivot bracket at the rear end of the tie bar;

FIG. 8 is a side view of the load bearing member when disconnected at a front end from the tie bar, and then rotated and moved into a vertical orientation in which the load bearing member is secured upright by the pivot bracket;

FIG. 9 is a perspective view of an alternative design of pivot bracket for a load bearing frame according to a second preferred embodiment of the invention;

FIGS. 10 to 12 are side views showing how a pivot pin connected to the load bearing member is inserted into a first channel in the pivot bracket and seated in a pivot at an end of the channel;

FIG. 13 shows how the pivot pin when seated allows the load bearing member to rotate to the upwards sloping orientation shown in FIG. 1;

FIG. 14 shows how the pivot pin allows the load bearing member to rotate to the horizontal orientation shown in FIG. 3;

FIG. 15 is a top view of FIG. 14, showing the pin, and also a locking pin offset from the pivot pin; and

FIG. 16 is a side view showing how both the pivot pin and locking pin are inserted into a second channel in the pivot bracket to secure the load bearing member in the vertical orientation, similar to that of FIG. 8.

### DETAILED DESCRIPTION

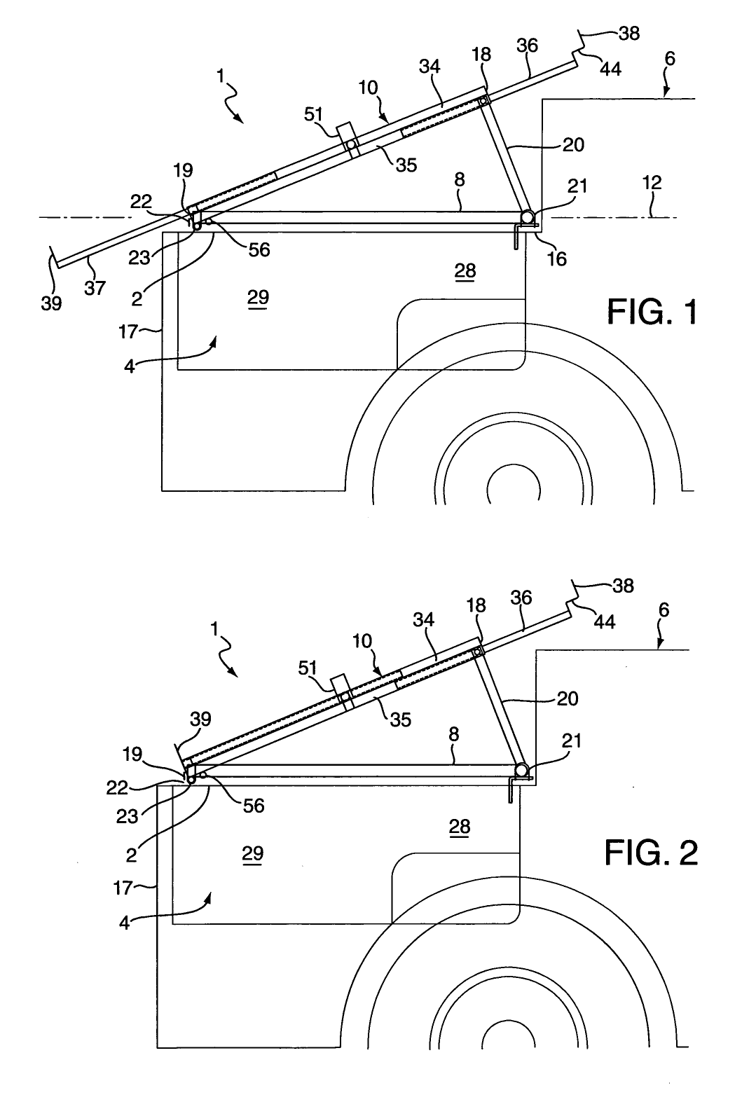

FIGS. 1 and 2 show a load bearing frame 1 affixed to the rim 2 of an open-top rear cargo box area 4 of a pick-up truck 6. The frame 1 has mounting means 8 for mounting the frame 1 to the rim 2 of the cargo box area 4, an elongate load bearing member 10 which extends along a longitudinal axis 12 of the pick-up truck 6.

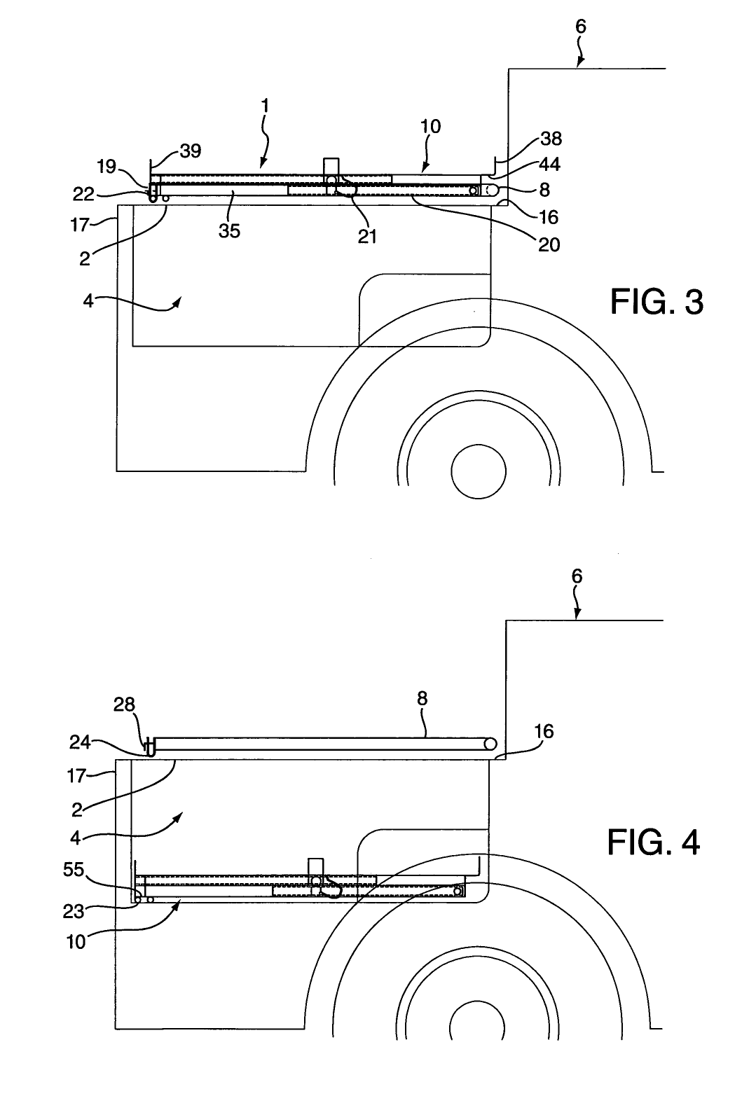

The mounting means 8 is shown most clearly in FIGS. 4-6, and takes the form of a circular cross-section bar which extends around left, right and front sides 14, 15, 16 of the cargo box area 4. The bar is similar to tie bars commonly used with pick-up trucks to which ropes or fabric covers are often fixed when securing or covering a load held within the cargo box area. Although not shown in the drawings, such bars can be fixed to the rim using screws or bolts fixed to captive nuts inside the rim 2.

The load bearing member 10 is secured at front and rear ends 18, 19 to the tie bar 8 via supporting means, which in this example includes a forwards leg 20 and a pair of rear pivots 22. The leg terminates in a shackle 21 which can be removeably fixed to the tie bar 8 at the centre of the forwards edge 16 of the cargo box area 4. The pivots 22 are provided at left and right rear ends 25, 26 of the tie bar 8. Each pivot 22 includes a projecting cylindrical pin 23 that extends transversely left or right away from the axis 12 and which is seated in a U-shaped pivot bracket 24 at the ends 25, 26 of the tie bar 8. The pivot pin 23 is secured to the pivot bracket by means of a pull-out pin 28, seen most clearly in FIG. 4.

As shown in FIGS. 1 and 2, the supporting means 20-24 is arranged to support the forwards end 18 of the load bearing member 10 at a higher level than the rearwards end 19 of the load bearing member 10. The load bearing frame 1 is therefore mounted to the rim 2 of the cargo box area 4 with the forwards end 18 above a forwards portion 28 of the cargo box area 4 and the rearwards end 19 above a rearwards portion 29 of the cargo box area 4.

This permits a user to load (not shown) goods or materials, particularly sheet-like materials from a rear side 17 of the cargo box area 4, by pushing the goods or materials up onto the load bearing member 10.

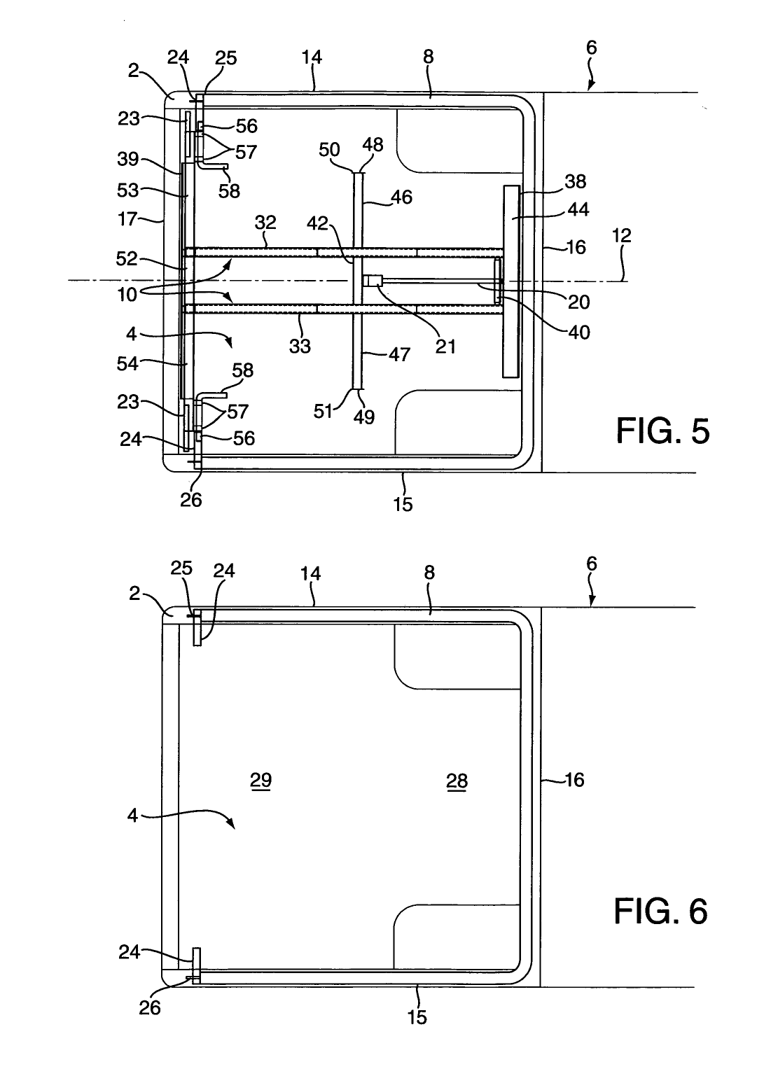

As shown in FIG. 5, the load bearing member 10 is formed from a pair of parallel beams 32, 33, spaced equidistantly on left and right sides of the longitudinal axis 12. As shown in FIGS. 1-4, each beam 32, 33 is formed from two square hollow cross-section tubes 34, 35 permanently secured together, one above the other, each of which extends the full length of the load bearing member 10 between forwards and rearwards ends 18, 19. Each of the hollow tubes 34, 35 holds inside at forwards and rearwards ends, respectively, forwards and rearwards telescopic extensions 36, 37. In this example, the forwards telescopic extension 36 is in the lower tube 35 and the rearwards extension 37 is in the upper tube 34, however, this arrangement could be reversed.

Each extension 36, 37 can be secured in a desired longitudinal orientation, depending on the length of the load to be carried. This securing of the telescopic extensions 36, 37 could be done by providing for each extension telescopic securing means, for example a wing nut (not shown) which is threaded through a tapped hole in the surrounding tube 34, 35, and which when tightened bears against a portion of the extension within the tube to lock this in place.

Each of the extensions has fixed at its farthest end a bracket 38, 39 which extends upright at right angles to the length of the load bearing member 10. The forwards bracket 38 extends transversely between the forwards extensions 36, and similarly the rearwards bracket 39 extends transversely between the rearwards extensions 37. An advantage of this arrangement is that if one of the telescopic securing means comes loose for one or the other of the forwards or rearwards extensions, the other of the telescopic extensions may still be securely fixed, and so the extension of the bracket will remain secured in place.

As can be seen in FIG. 5, each of the upright brackets 38, 39 extends transversely left and right beyond the pair of longitudinal beams 32, 33, which helps to secure in a forwards or rearwards longitudinal direction a load or goods or sheet material supported by the load bearing means 10.

One option, not shown in the drawings, is to provide with the brackets another bracket or flange arranged to clamp a load against the load bearing member 10. This could take the form of a flange or a plate extending transversely inwards from each bracket 38, 39 in a direction parallel with the load bearing member.

The load bearing frame 1 may be lowered when not in use, as shown in FIG. 3. Here, the shackle 21 has been disconnected from the tie bar 8. As shown in FIG. 5, the forwards supporting leg 20 is rotationally joined to both of the longitudinal beams 32, 33 by means of a rod 40 which extends transversely between the beams. This permits the leg 20 to be rotated backwards and upwards into the plane of the load bearing means 10, and then to be secured to a transverse member 42 which extends between the longitudinal beams 32, 33. The load bearing means can then be pivoted downwards about the rear pivots 22 until a horizontal plate 44 at the base of the forwards bracket 38 comes to rest against the forwards section of the tie bar 8.

The load bearing means 10 includes a pair of tubular lateral supports 46, 47 which extend transversely from the upper tube 34 on opposite left and right sides. Each of the lateral supports 46, 47 is a hollow tube of square cross-section and contains a telescopic lateral extension 48, 49, in a similar manner to that for the upper and lower tubes 34, 35. Each lateral extension 48, 49 is shown here in a retracted orientation, and has fixed at its farthest end a bracket 50, 51 which extends upright at right angles to the length of the load bearing member 10.

Each extension 48, 49 can be secured in a desired lateral orientation, depending on the width of the load to be carried. This securing of the lateral telescopic extensions 48, 49 could be done by providing for each extension telescopic securing means, for example a wing nut (not shown) which is threaded through a tapped hole in the surrounding lateral tubular support 46, 47 and which when tightened bears against a portion of the lateral extension within the tube to lock this in place.

One option, not shown in the drawings, is to provide with the lateral brackets another bracket or flange arranged to clamp a load against the load bearing member 10. This could take the form of a flange or a plate extending transversely inwards from each lateral bracket 50, 51 in a direction parallel with the load bearing member.

The load bearing means 10 includes a further lateral support, at the rear end 19 of the load bearing member 10, namely an intermediate lateral support 52, and left and right lateral supports 53, 54 which extend transversely from both the upper and lower tubes 34 on opposite left and right sides of the load bearing member 10. These lateral supports 52-54 are is formed from two square hollow cross-section tubes permanently secured together, one above the other, of similar cross-sectional dimensions and in the same plane as that of the upper and lower longitudinal tubes 34, 35.

The pivot pins 23 are fixed to the lowermost surface 55 at the end of each left and right lateral support 53, 54 so that each pin 23 extends laterally beyond these supports 53, 54.

A second slidable pin or bolt 56 is provided at the end of each left and right lateral support 53, 54. The bolt 56 is held within a pair of loops 57 that extend forwards of the lowermost surface 55 of the supports 53, 55. Each bolt 56 extends laterally beyond the lateral supports 53, 54, parallel to but offset in a longitudinal direction from the fixed pins 23. Each bolt 56 has a handle 58 which permits the bolt 56 to be moved manually left or right.

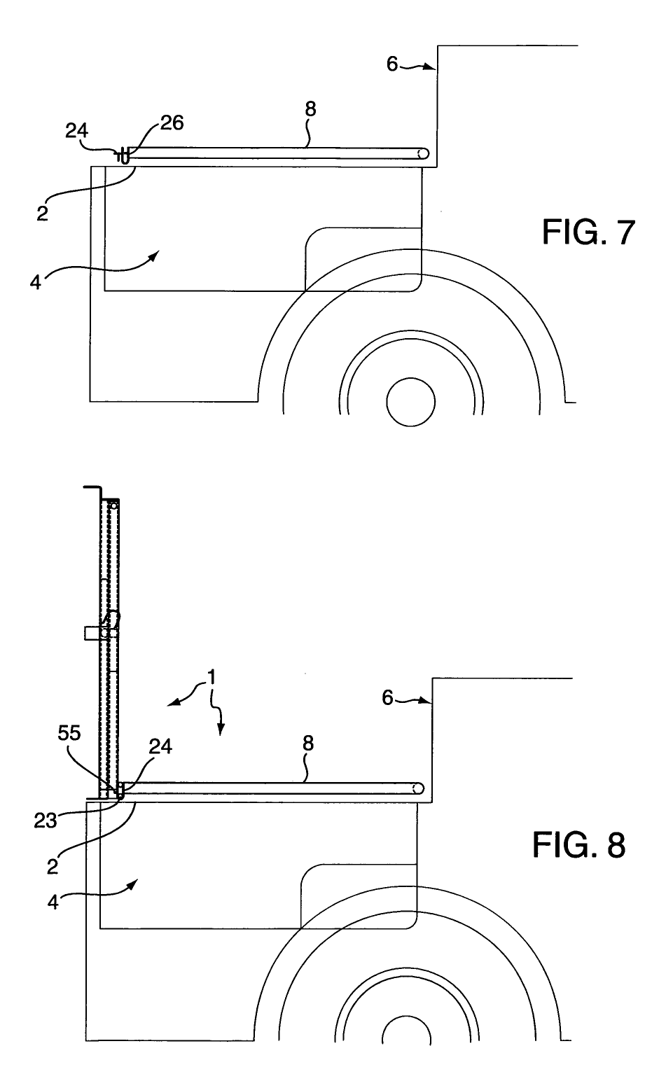

The purpose of the slidable pins or bolts 56 is to lock the load bearing means 10 in a vertical orientation, by moving the bolts 56 laterally outwards into the U-shaped pivot bracket 24 as shown in FIG. 8, so that ready access may be had to the cargo box area 4. When the load bearing from 10 is lowered again into position for use, the bolts are moved laterally inwards, thus releasing the vertical lock.

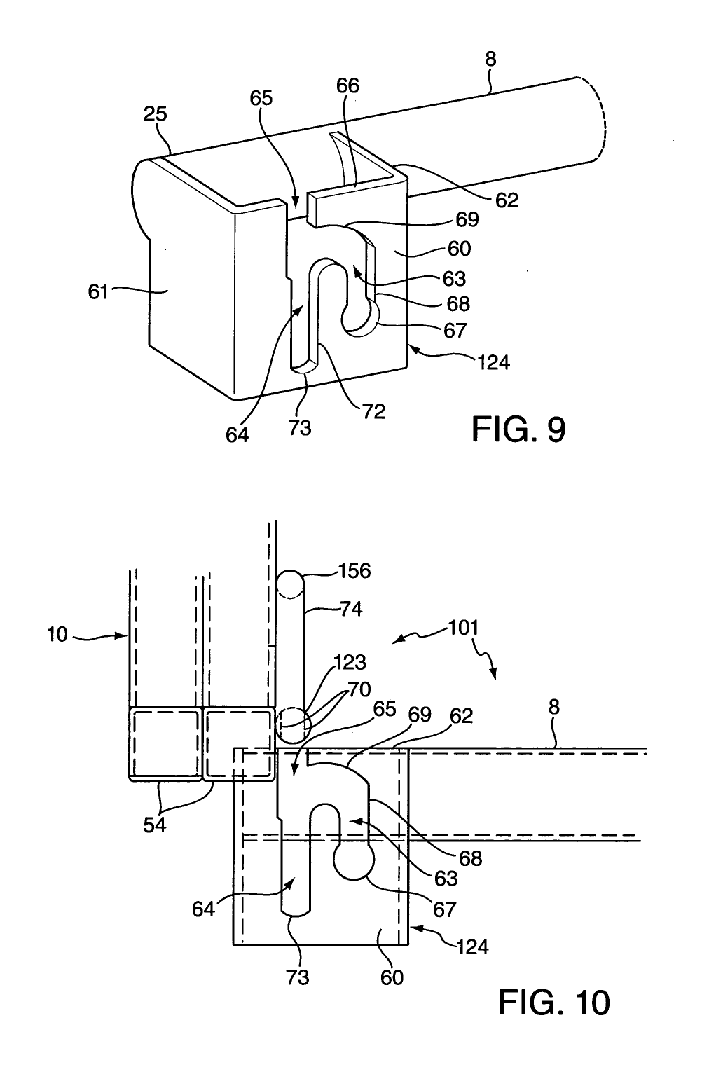

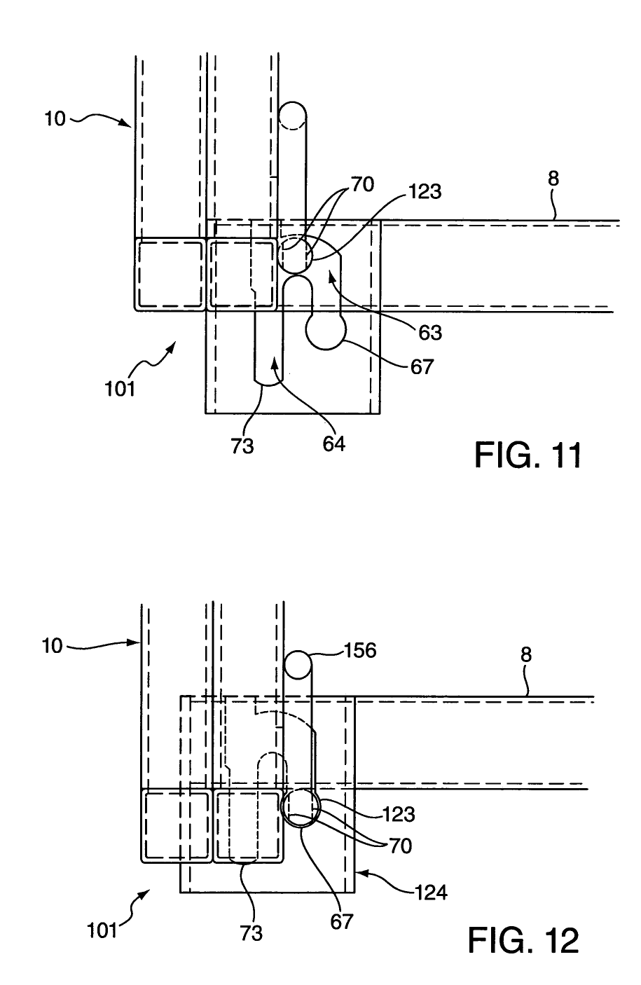

FIG. 9 is a perspective view of an alternative design of pivot bracket 124 for a load bearing frame 101 according to a second preferred embodiment of the invention. FIGS. 10 to 16 illustrate how the pivot bracket 124 is used with a projecting pivot pin 123 to form a rear pivot 122 and how the pivot bracket 124 is used with a locking pin 156 to lock the load bearing means 10 in a vertical orientation. The frame 101 is identical to that of the first embodiment, apart from the operation of the rear pivots 122 and the vertical locking of the load bearing means 10. The features which are common to the two embodiments 1, 101 will not therefore be described again.

As with the first embodiment, there is a pair of rear pivots 122, each with a pivot bracket 124. Each pivot bracket has a vertical plate 60 which extends in the longitudinal direction parallel with axis 12. Each plate 60 is fixed to an end 25, 26 of the tie bar 8, and is spaced parallel to and laterally inside of the tie bar at the ends 25, 26 by means of a pair or parallel, longitudinally offset vertically extending flanges 61, 62 which extend perpendicularly to the length of the tie bars at the ends 25, 26.

The plate 60 has two channels, namely a first channel 63 and a second channel 64, which are connected together at a common entrance 65 in an upper surface 66 of the plate 60. The first channel 63 leads down from the entrance 65 towards an end 67 of the first channel. The first channel end 67 has a semi-circular shape, extending over 180°, as a mid-portion 68 of the first channel has a width less than the diameter of the semi-circular end 67. The first channel 67 then has an upper portion 69 which curves rearward and then finally directly upwards to the channel entrance 65. The channel upper portion 69 has a greater width than the channel mid portion 68, so that the channel mid-portion forms a neck in the first channel 63.

The reason for this arrangement can be seen from FIGS. 10-12 which show how the each projecting pivot pin 123 inserts into the corresponding first channel 63 to seat in the lower end 67 of the first channel 63 to form a rear pivot 122.

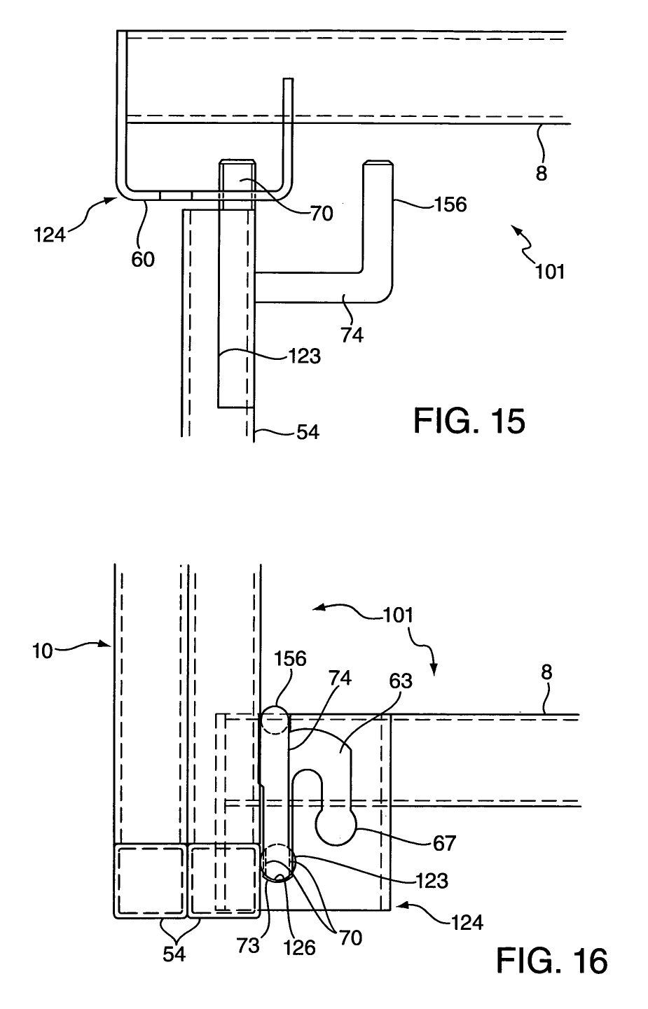

As shown in FIG. 15, and as visible in dashed line in FIGS. 10-12, each of the pivot pins 123 is cylindrical except for a pair of flats 70 on opposite sides of the pin 123. The width of the pins 123 between the flats 70 is just less than the width of the channel neck 68, and the diameter of the pin cylindrical surfaces is greater than that of the channel neck 68, but less than that of the diameter of the first channel semicircular end 67.

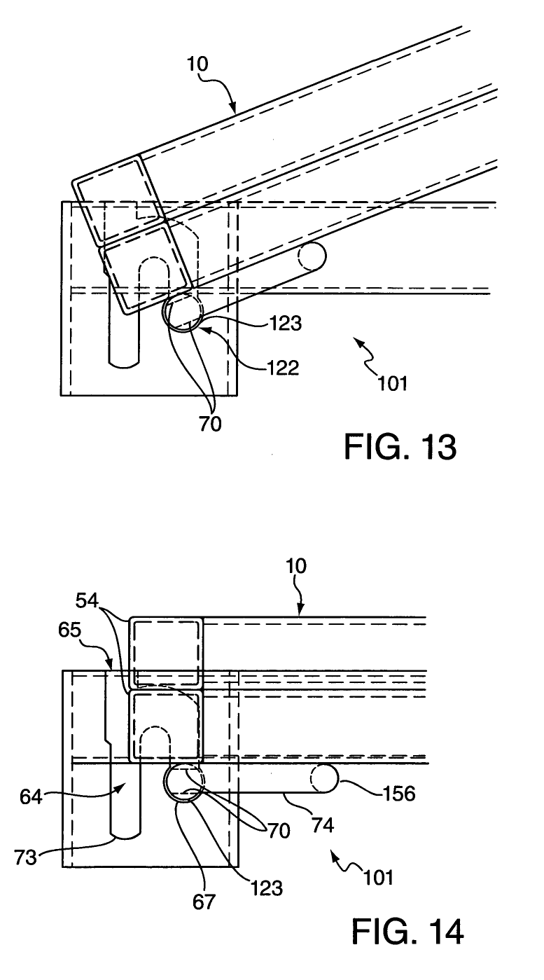

When the load bearing means 10 is vertically oriented, these flats 70 are also vertically oriented, so that as the load bearing means is lowered into the channel opening 65, and then forwards and downwards past the first channel upper portion 69, the flats 70 of each of the pivot pins 123 pass downwards into the channel end. Then, as shown in FIG. 13, the load bearing frame 10 can be rotated downwards into position for use. Because the pin flats 70 have also been rotated, the pin can no longer be withdrawn upwards through the channel neck 68, and so the pivot pins are securely retained in the semi-circular channel ends 67. The engagement between the cylindrical surface of each pivot pin 123 and the corresponding channel end 67 provide the pair of rear pivots 122 for the load bearing frame 101.

As shown in FIG. 14, the load bearing frame 10 can be further rotated to a horizontal position when not in use, similar to the illustration of FIG. 3.

Each of the second channels 64 is connected to the corresponding first channel 63 at the channel entrance 65. The second channel leads straight down from the entrance, and has a mid and lower portion 72 with a width sufficient only to allow passage of the pivot pins 123 when the flats 70 are oriented vertically. The second channel terminates at a curved end 73.

As shown in FIG. 15, the distance between the locking pin 156 and the pivot pin 123 is determined by an arm 74 that extends in a longitudinal between these two pins. In use, the arm 74 is offset laterally inwards from the pivot bracket 124 so that the arm 74 does not interfere with the pivot bracket as the load bearing means is moved and rotated.

The distance in a straight line from the bracket upper surface 60 to the end 73 of the second channel 64 is greater than the corresponding distance in a straight line for the first channel 63, and is greater than the separation between the pivot pin 123 and the locking pin 156. Therefore, while the locking pin 156 remains free of the pivot bracket 124 bracket when the pivot pin is engaged in the end 67 of the first channel, as also as the load bearing means 10 is rotated forwards and downwards, the locking pin 156 does enter the channel entrance 65 as the pivot pin enters the second channel 64. As result the engagement of both pins 123, 156 in the second channel 64 secures the vertical orientation of the load bearing means 10 when clear access to the cargo box area 4 is needed, as illustrated in FIG. 8.

When such access is no longer needed, the load bearing means is lifted so that the locking pin 156 is removed from the channel entrance 65 until the pivot pin 123 can be moved forwards and downwards into the first channel 63, as shown in FIGS. 10-13.

The invention therefore provides a convenient load bearing frame, and in particular a load bearing frame for mounting to the cargo box area of a pickup truck or other light motor vehicle having an open-top rear cargo box area.

1. A load bearing frame for mounting to a motor vehicle having an open-top rear cargo box area, the frame comprising:
mounting means for mounting the frame to a rim of the cargo box area;
a load bearing member for carrying sheet loads, said member defining a longitudinal direction and having opposite first and second ends;
supporting means for supporting the load bearing member on the mounting means; and
means for restraining in the longitudinal direction a sheet load placed on the load bearing member;
wherein the supporting means is arranged to support the first end of the load bearing member at a higher level above the mounting means than the second end of the load bearing member, such that the load bearing frame may, in use, be mounted to the rim of the cargo box area with the first end above a forwards portion of the cargo box area and the second end above a rearwards portion of the cargo box area, and said longitudinal restraining means is extendable in the longitudinal direction from said first end and/or said second end so that in use sheet loads of differing length can be carried by the load bearing member.

2. A load bearing frame as claimed in claim 1, in which the load bearing member is elongate along the longitudinal direction.

3. A load bearing frame as claimed in claim 1, in which the frame comprises means for restraining in a horizontal direction transverse to the longitudinal direction a load placed on the load bearing member.

4. A load bearing frame as claimed in claim 3, in which said horizontal restraining means is extendable in the horizontal direction left and/or right with respect to the longitudinal direction.

5. A load bearing frame as claimed in claim 1, in which said longitudinal restraining means includes a bracket extending upwards from one or both ends of the load bearing member.

6. A load bearing frame as claimed in claim 5, in which said bracket includes a clamp for clamping a load towards the load bearing member.

7. A load bearing frame as claimed in claim 3, in which the transverse restraining means includes a bracket extending upwards at one or both sides of the load bearing member.

8. A load bearing frame as claimed in claim 7, in which said bracket includes a clamp for clamping a load towards the load bearing member.

9. A load bearing frame as claimed in claim 1, in which the load bearing member is removably affixed to the mounting means via the supporting means.

10. A load bearing frame as claimed in claim 1, which the supporting means includes pivoting means by which load bearing member may pivot with respect to the mounting means so that in use the load bearing member can be pivoted to gain better access to the cargo box area.

11. A load bearing frame as claimed in claim 10, in which said pivoting means permits the load bearing member to be pivoted to a substantially vertically extending orientation.

12. A load bearing frame as claimed in claim 11, in which said pivoting means includes means for temporarily securing the load bearing member in said vertically extending orientation.

13. A load bearing frame as claimed in claim 10, in which the supporting means includes a pair of pins extending in opposite horizontal directions, said pins each engaging in a pivot affixed to the mounting means.

14. A load bearing frame as claimed in claim 13, in which:
said pins have a non-circular cross-section with a major cross-sectional axis and a minor cross sectional axis;
each of said pivots is provided in a pivot bracket;
each of said pivot brackets has a first channel extending upwardly from the pivot;
at least a portion of each of said first channels has a width sufficient to allow passage for the minor cross-sectional axis but not the major cross-sectional axis;
the minor cross-sectional axes of the pins are oriented to permit passage of the pins through said first channel when the load bearing member is pivoted to a vertical orientation.

15. A load bearing frame as claimed in claim 14, in which each of said first channels leads to an opening which permits the load bearing frame to be removed from the bracket by moving the load bearing frame upwards with respect to the bracket.

16. A load bearing frame as claimed in claim 14, in which:
each bracket has a second channel connected to the first channel;
each of said second channels is offset in a longitudinal direction relative to the corresponding pivot;
the load bearing frame comprises a pair of projections;
each of said projections is in fixed proximity with a corresponding one of said pins, the arrangement being such that the load bearing member when in a substantially vertical orientation may be moved to engage both said pins and said projections in the second channel to secure the load bearing member in said substantially vertical orientation.

17. A load bearing frame as claimed in claim 16, in which the first and second channels together form an inverted U-shape plus a section of channel extending upwardly from said inverted U-shape towards an opening to said channels through which the pin passes when the load bearing member is being fixed to or removed from said pivots.

18. A load bearing frame as claimed in claim 1, in which the supporting means includes at the first end and/or at the second end of the load bearing member a horizontally extending transverse member.

19. A load bearing frame as claimed in claim 1, in which the supporting means includes a pair of legs which in use extend downwardly from the load bearing member to a forward portion of the mounting means.

20. A light motor vehicle, comprising an open-top rear cargo box area, the vehicle having a load bearing frame comprising:
mounting means for mounting the frame to a rim of the cargo box area;
a load bearing member for carrying sheet loads, said member having opposite first and second ends;
supporting means for supporting the load bearing member on the mounting means; and
means for restraining in the longitudinal direction a sheet load placed on the load bearing member;
wherein the supporting means is arranged to support the first end of the load bearing member at a higher level above the mounting means than the second end of the load bearing member, such that the load bearing frame is mounted to the rim of the cargo box area with the first end above a forwards portion of the cargo box area and the second end above a rearwards portion of the cargo box area, and said longitudinal restraining means is extendable in the longitudinal direction from said first end and/or said second end so that in use sheet loads of differing length can be carried by the load bearing member.
